(19) United States
(12) Patent Application Publication
(10) Pub. No.: US 2012/0102894 A1
(43) Pub. Date: May 3, 2012

(54) Power Dock Box

(76) Inventors: David Lee TerHaar, Allegan, MI (US); Matthew John Lepard, Holland, MI (US)

(21) Appl. No.: 13/098,040

(22) Filed: Apr. 29, 2011

Related U.S. Application Data
(60) Provisional application No. 61/343,453, filed on Apr. 29, 2010.

(51) Int. Cl. B65D 51/00; G06F 7/04; G05B 11/01; B65B 43/26

(52) U.S. Cl. 53/492; 220/212; 340/5.6; 340/12.5

(57) ABSTRACT

A box assembly includes a base defining an interior storage compartment, a lid movable relative to the base to selectively cover the interior storage compartment, a base plate adapted to be fixedly mounted to the lid, a power source disposed along the base plate, a power actuator disposed along the base plate and electrically connected to the power source, a latch mechanism disposed along the base plate and operably connected to the power actuator for movement between a locked position, in which the lid is retained against the base, and an unlocked position, in which the lid is movable relative to the base, and a keyless entry receiver disposed along the base plate and operably coupled to the power actuator, the keyless entry receiver actuating the power actuator to move the latch mechanism from the locked position to the unlocked position in response to a signal from a transmitter.

This application claims the domestic benefit of U.S. provisional application Ser. No. 61/343,453 filed on Apr. 29, 2010, the disclosure of which is herein incorporated by reference in its entirety.

### FIELD OF THE INVENTION

The invention relates to a box for the storage of items. More particularly, the invention relates to a box including a latch mechanism and at least one light source that can be operated in conjunction with a remote keyless entry system.

### BACKGROUND OF THE INVENTION

Dock boxes are in common use on docks, in marinas and on boats. Dock boxes provide a convenient place for the secure storage of personal items and boating equipment. There are many different kinds of dock boxes for example, a standard dock box provides a large space in which to stow all your boating gear; a seat-top dock box provides the interior storage compartment, but also has a seat built into the lid to enable a boater to sit thereon. Dock boxes are built to endure ruthless weather conditions and severe marine environments year after year.

### SUMMARY OF THE INVENTION

According to one aspect of the invention, a box assembly includes a base defining an interior storage compartment, a lid movable relative to the base to selectively cover the interior storage compartment, a base plate adapted to be fixedly mounted to the lid, a power source disposed along the base plate, a power actuator disposed along the base plate and electrically connected to the power source, a latch mechanism disposed along the base plate and operably connected to the power actuator for movement between a locked position, in which the lid is retained against the base, and an unlocked position, in which the lid is movable relative to the base, and a keyless entry receiver disposed along the base plate and operably coupled to the power actuator, the keyless entry receiver actuating the power actuator to move the latch mechanism from the locked position to the unlocked position in response to a signal from a transmitter.

According to another aspect of the invention, a box assembly includes a base defining an interior storage compartment, a lid movable relative to the base to selectively cover the interior storage compartment, the lid having a top wall and exterior side walls extending out therefrom, a base plate adapted to be fixedly mounted to the top wall of the lid, a power source disposed along the base plate, a power actuator disposed along the base plate and electrically connected to the power source, and an interior light source disposed along the base plate and electrically connected to the power source for illuminating the interior storage compartment.

According to yet another aspect of the invention, a modular powered accessory assembly for a box having a base and a lid defining an interior storage compartment includes a base plate adapted to be fixedly mounted to the lid, a power source disposed along the base plate, a power actuator disposed along the base plate and electrically connected to the power source, a latch mechanism disposed along the base plate and operably connected to the power actuator for movement between a locked position and an unlocked position, an interior light source coupled to the base plate and electrically connected to the power source to illuminate the interior storage compartment, an exterior light source adapted to be mounted along an outboard surface of the lid and electrically connected to the power source to illuminate an area adjacent the box, and a keyless entry receiver disposed along the base plate and operably coupled to a transmitter for operating at least one of the latch mechanism, the interior light source, and the exterior light source.

According to still another aspect of the invention, a method for opening a box, having a lid movable relative to a base, utilizes a remote control and includes the steps of activating the remote control; and unlocking the latch mechanism to move the lid relative to the base.

According to still another aspect of the invention, a method of remotely actuating at least one of an interior light source and an exterior light source for a box defining an interior storage compartment utilizes a remote control and includes the steps of activating the remote control; and turning on at least one of the interior and exterior light sources to illuminate at least one of the interior storage compartment and an area adjacent the box.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a box assembly according to one embodiment of the invention including an exterior light source mounted thereto;

FIG. 2 is a perspective view of the box assembly in an open position;

FIG. 3 is a enlarged perspective view of the box assembly including a latch mechanism secured to a lid for engagement with a striker disposed along a base;

FIG. 4 is a perspective view of a cover piece including an interior light source mounted thereto;

FIG. 5 is a top view of a back plate including the latch mechanism, a power actuator, a power source, and a remote keyless receiver mounted thereto;

FIG. 6 is a perspective view of the striker mounted along the base; and

FIG. 7 is a rear perspective view of the back plate including a key lock assembly.

### DETAILED DESCRIPTION OF THE ILLUSTRATED EMBODIMENT

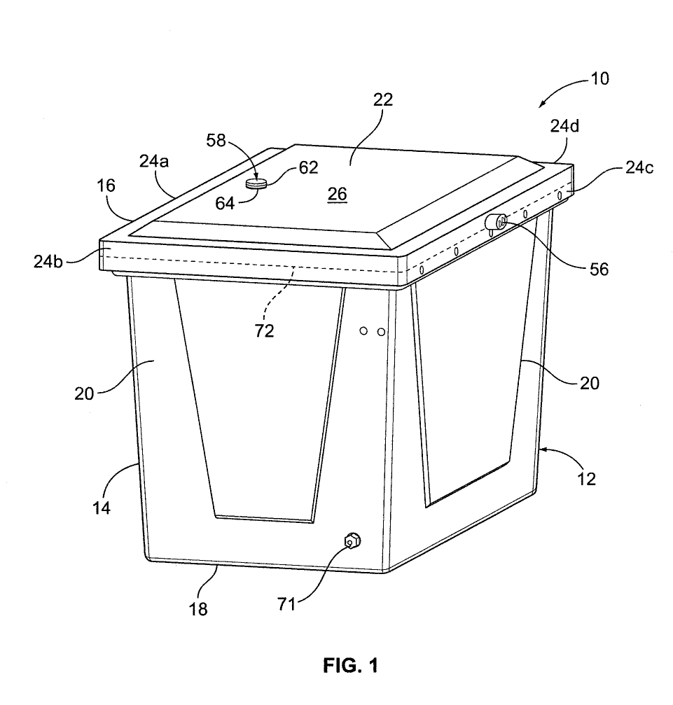

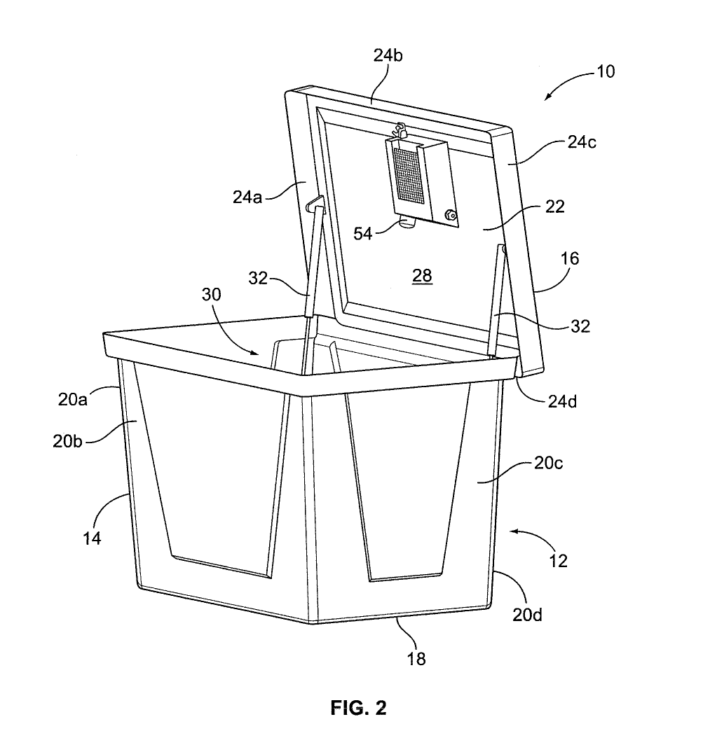

Referring to FIGS. 1 and 2, a box assembly 10 includes a box 12 having a base 14 and a lid 16 movable relative to the base 14. The base 14 includes a bottom wall 18 and side walls 20a, 20b, 20c, 20d extending upwards from each edge of the bottom wall 18. The lid 16 includes a top wall 22 and side walls 24a, 24b, 24c, 24d extending from each edge of the top wall 22. The top wall 22 has an outer surface 26 and an inner surface 28. The base 14 and the lid 16 define an interior storage compartment 30. When in the closed position, the side walls 24a, 24b, 24c, 24d of the lid 16 overlays the respective side walls 20a, 20b, 20c, 20d of the box 12. This aids in preventing rain water from entering into the storage compartment 30. If desired, a gasket (not shown) can be provided on the exterior surfaces of the walls 20a, 20b, 20c, 20d of the box 12 or the interior surfaces of the side walls 24a, 24b, 24c, 24d of the lid 16 to provide a more weather tight seal. While the box 12 and the lid 16 are shown as square, other configuration can be provided, such as round, rectangular, triangular, etc. The box 12 and the lid 16 are preferably formed from fiberglass or plastic. If formed from fiberglass, an interior liner can be provided to provide a smooth interior. The box assembly 10 is designed to endure ruthless weather conditions and severe marine environments year after year.

The box assembly 10 includes pneumatic cylinders 32 which bias the lid 16 away from the base 14 when the box 12 is unlocked in order to open the box 12. When in an open position, wall 24b is moved to be the furthest away from the box 14, while wall 24d is proximate to the box 14. This allows a user to easily access the storage compartment 30 within the box 14. The pneumatic cylinders 32 can be adjusted to move the lid 16 as little as one inch to partially open the box 12 or to move the lid 16 along its entire range of motion to completely open the box 12. Since pneumatic cylinders 32 are used, the lid 16 remains open on rocking docks and allow for slower, more controlled closing in high winds.

It is appreciated that the box 12 may be any type of box or container used for storing any of various items such as tools, gardening supplies, art supplies, and the like. Preferably, the box assembly 10 is for use as a dock box which is typically installed at a marina, harbor or on a boat for the secure storage of personal items and boating equipment.

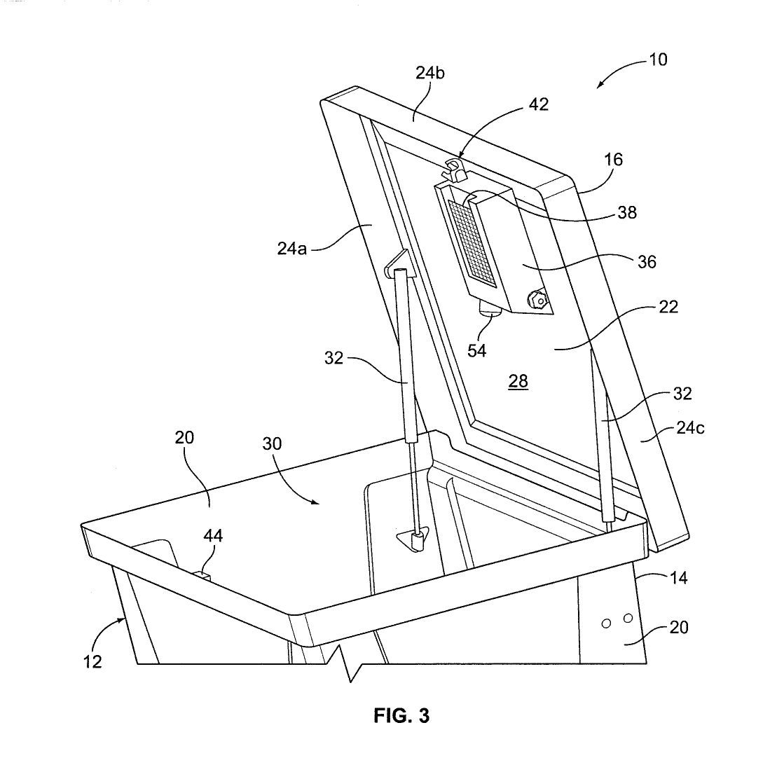

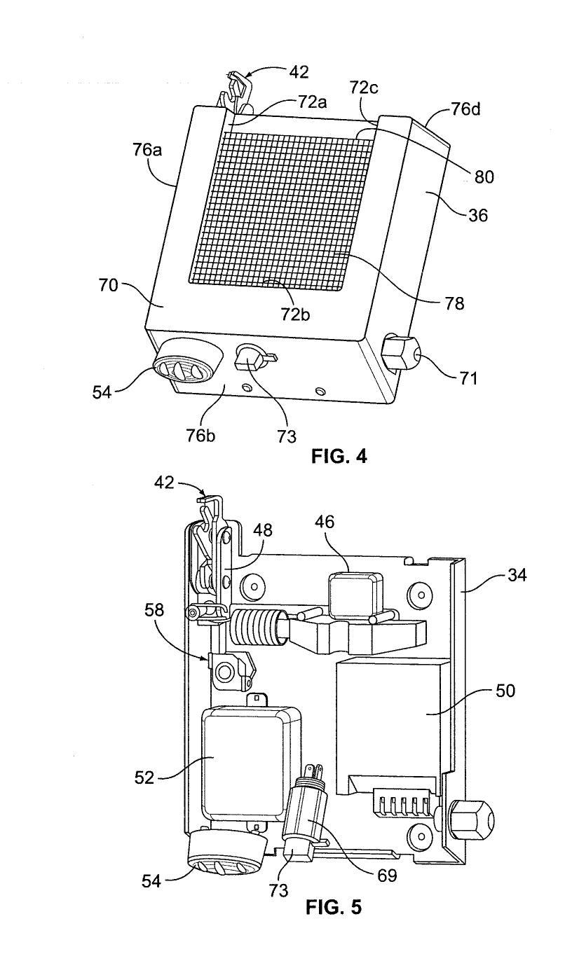

Referring to FIGS. 3 through 5, a back plate 34 and a cover piece 36 are attached to the lid 16 of the box 12. More specifically, the back plate 34 is mounted to the inner surface 28 of the top wall 22 of the lid 16.

The cover piece 36 covers the back plate 34 to protect various components that are mounted thereto. The cover piece 36 includes a base wall 70 which is parallel to the top wall 22 of the lid 16, a recess provided in the base wall 70 which is defined by three side walls 72a, 72b, 72c extending perpendicularly from the base wall 70 and a bottom wall 74 which is parallel to the base wall 70, and side walls 76a, 76b, 76c, 76d extending from each edge of the base wall 70 and from the edge of the bottom wall 74. The side walls 76a, 76b, 76c, 76d angle outwardly relative to the base wall 70. A net 78 is attached to the side walls 76a, 76b, 76c and overlays substantially all of the bottom wall 74 to form a storage compartment 80. The storage compartment 80 is open at the end proximate to the side wall 76d. The storage compartment 80 is utilized for the storage of smaller items such as wallets, keys, glasses, cell phones, and the like. In another embodiment, the cover piece 36 may include a pocket with a zipper for the storage of such smaller items.

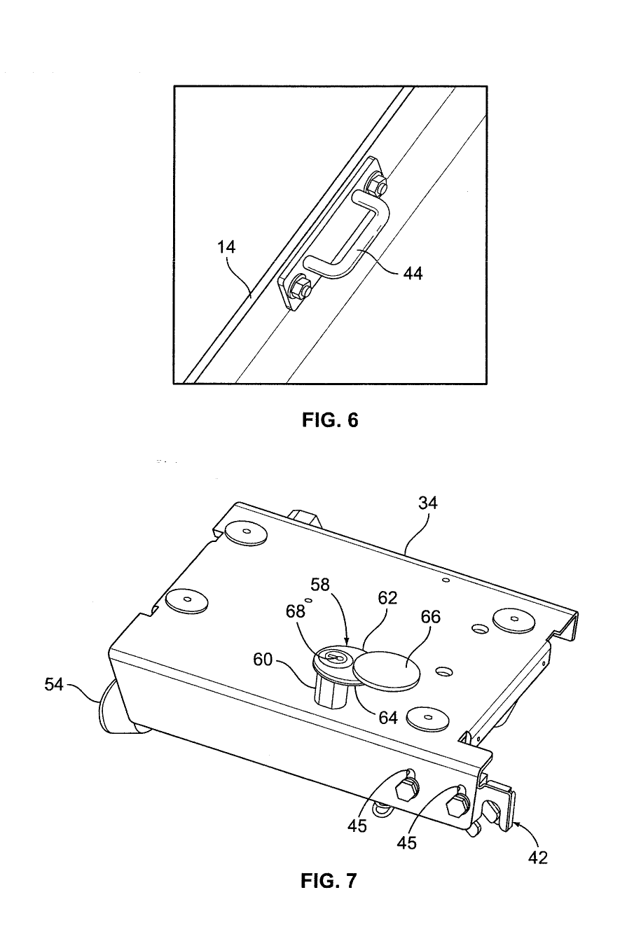

Referring to FIG. 5, a latch mechanism 42 is coupled to the lid 16. In one embodiment, the latch mechanism 42 is disposed along the back plate 34. The latch mechanism 42 is described in U.S. Patent Application Publication No. 2007/0170728, the content of which is hereby incorporated by reference in its entirety. The latch mechanism 42 is movable between a locked position, in which the latch mechanism 42 engages a striker 44 (shown in FIGS. 3 and 6) mounted along the base 14 to retain the box 12 in a closed configuration, and an unlocked position, in which the latch mechanism 42 releases the striker 44 to allow movement of the lid 16 relative to the base 14 to open the box 12. The back plate 34 includes mounting slots 45 (shown in FIG. 7) which allow for position adjustment of the latch mechanism 42 relative to the back plate 34 to accommodate for variations in striker location. This ensures a tight fit between the lid 16 and the base 14.

The latch mechanism 42 is operable by a power actuator 46 which is mounted relative to the latch mechanism 42 by an actuator bracket 48. The power actuator 46 is electrically connected to a power source 50. The power source 50 may be secured to the back plate 34.

The power actuator 46 is operated by a remote keyless entry system. In one embodiment, the remote keyless entry system utilizes a key fob. In another embodiment, the remote keyless entry system utilizes a keypad display that is located along an exterior of the lid 16. It is, however, appreciated that any other of numerous remote controls as known to those of ordinary skill in the art may be utilized in the remote keyless entry system. A remote keyless receiver 52 may be mounted to the back plate 34. The remote keyless receiver 52 receives a code or signal from the key fob, the keypad display, or the remote control and generates an operational signal. The operational signal may actuate the power actuator 46 to release the latch mechanism 42 to open the lid 16 and/or the operational signal may turn on one or both of an interior light source 54 and an exterior light source 56.

Referring to FIGS. 1 and 7, the box assembly 10 includes a key lock assembly 58 which is operably connected to the latch mechanism 42 to allow manual locking and unlocking of the latch mechanism 42. The key lock assembly 58 includes a key cylinder 60 extending through an opening in the top wall 22 of the lid 16. The key cylinder 60 includes a flange 62 supported against the top wall 22 of the lid 16. A gasket 64 is disposed between the flange 62 and the top wall 22 to prevent the key lock assembly 58 from scratching the lid 16. The key lock assembly 58 also includes a cover 66 which selectively covers a key slot 68. Because the key lock assembly 58 is operably connected to the latch mechanism 42, inserting a key into the key slot 68 will disengage the latch mechanism 42 from the striker 44. Thus, the key lock assembly 58 may be utilized to lock and unlock the box 12 in those instances in which the latch mechanism 42 is not receiving power or has otherwise failed to operate.

Referring now to FIG. 5, the back plate 34 includes a power receptacle 69 mounted thereto and electrically connected to the power source 50. The power receptacle 69 is covered by a cap 73. The power receptacle 69 in one embodiment is a 12 V outlet that can be utilized for charging cell phones and other portable devices.

A sealed cord grip 71 is provided through the side wall 20 of the base 14. A cord (not shown) may be passed therethrough to allow power to be supplied to the box assembly 10.

The box assembly 10 includes the interior light source 54 for illuminating the interior storage compartment 30 of the box 12. The interior light source 54 is electrically connected to the power source 50. In one embodiment, the interior light source 54 is an LED (light-emitting diode) lamp. It is, however, appreciated that the interior light source 54 may be any of various light sources including, but not limited to, an incandescent bulb or a fluorescent lamp. The interior light source 54 is mounted to side wall 76b of the cover piece 36. Since the side wall 76b of the cover piece 36 is angled relative to the top wall 22 of the lid 16 and the lid 16 is at an angle relative to the bottom wall 18 of the box 14, light emitted from the interior light source 54 is directed into the interior storage compartment 30 when the lid 16 is open.

The box assembly 10 also includes an exterior light source 56 mounted along an outer surface of the side wall 24d of the lid 16. The exterior light source 56 is mounted on the side wall 24d which is opposite to opening end of the lid 16 (i.e., the exterior light source 56 is mounted on the rear of the box assembly 10). The exterior light source 56 is electrically coupled to the power source 50 via a wire harness 72. In one embodiment, the exterior light source 56 is an LED (light-emitting diode) lamp. It is, however, appreciated that the exterior light source 56 may be any of various light sources including, but not limited to, an incandescent bulb or a fluorescent lamp. The exterior light source 56 is positioned on the lid 16 such that the exterior light source 56 emits light directly towards the ground (or the water as the case may be) to illuminate an area adjacent the box 12 when the box 12 is opened.

It is appreciated that operation of the interior light source 54 and the exterior light source 56 may be coordinated with the remote keyless entry system. For example, the interior light source 54 and the exterior light source 56 may automatically turn on once the latch mechanism 42 releases the striker 44 to open the box 12. A timer may be operably coupled to the interior 54 and exterior 56 light sources to automatically turn off the light sources 54, 56 after a certain amount of time has elapsed. For example, the interior 54 and exterior 56 light sources may be automatically turned off five minutes after the box 12 is opened by the remote keyless entry system. In alternative embodiments, the interior light source 54 and the exterior light source 56 are turned on or off by a remote control (independent of the remote keyless entry system) or by manual operation. In addition, the particular number and location of light sources 54, 56 associated with the box 12 may vary. Finally, it is also appreciated that any of a number of power sources for the interior 54 and exterior 56 light sources could be used including conventional alkaline batteries or rechargeable batteries.

It is contemplated that the components described above may be integrated directly into the box 12 such that certain elements described above, such as the base plate 34 and the power source 50, will not be required. As an example, the box assembly 12 may be manufactured with the latch mechanism 42 mounted directly to the inner surface 28 of the top wall 22 of the lid 16.

In another embodiment, the box assembly 12 requires only those components that remotely unlock the latch mechanism 42 to open the box 12. These components may include at least the key fob or remote control and the latch mechanism 42.

In yet another embodiment, the box assembly 12 requires only those components that remotely turn on at least one of the interior light source 54 and the exterior light source 56. These components may includes at least the key fob or remote control and one or both of the interior light source 54 and the exterior light source 56.

In the alternative, the components may be packaged in a modular powered accessory assembly available for purchase as an aftermarket accessory. The modular powered accessory assembly may include the base plate 34, the cover 36, the latch mechanism 42, the power actuator 46, the power source 50, the keyless entry receiver 52, the interior light source 54, and the exterior light source 56.

According to another embodiment, a method of opening the box 12, having the lid 16 movable relative to the base 14, utilizes a remote control and includes the steps of activating the remote control and unlocking the latch mechanism 42 to move the lid 16 relative to the base 14.

According to yet another embodiment, a method for remotely actuating one of the interior light source 54 and the exterior light source 56 for the box 12 defining the interior storage compartment 30 utilizes a remote control and includes the steps of activating the remote control and turning on one of the interior light source 54 and the exterior light source 56 to illuminate at least one of the interior storage compartment 30 and an area adjacent the box 12.

While preferred embodiments of the present invention are shown and described, it is envisioned that those skilled in the art may devise various modifications of the present invention without departing from the spirit and scope of the appended claims.

What is claimed:

1. A box assembly comprising:
a base defining an interior storage compartment;
a lid movable relative to said base to selectively cover said interior storage compartment;
a base plate fixedly mounted to said lid;
a power source disposed along said base plate;
a power actuator disposed along said base plate and electrically connected to said power source;
a latch mechanism disposed along said base plate and operably connected to said power actuator for movement between a locked position, in which said lid is retained against said base, and an unlocked position, in which said lid is movable relative to said base; and
a keyless entry receiver disposed along said base plate and operably coupled to said power actuator, said keyless entry receiver actuating said power actuator to move said latch mechanism from said locked position to said unlocked position in response to a signal from a transmitter.

2. A box assembly comprising:
a base defining an interior storage compartment;
a lid movable relative to said base to selectively cover said interior storage compartment, said lid having a top wall and exterior side walls extending out therefrom;
a base plate fixedly mounted to said top wall of said lid;
a power source disposed along said base plate;
a power actuator disposed along said base plate and electrically connected to said power source; and
an interior light source disposed along said base plate and electrically connected to said power source for illuminating said interior storage compartment.

3. The box assembly as set forth in claim 2 including an exterior light source mounted along an outboard surface of one of said exterior side walls of said lid and electrically connected to said power source to illuminate an area adjacent said box assembly.

4. A modular powered accessory assembly for a box having a base and a lid defining an interior storage compartment, said power assembly comprising:
a base plate fixedly mounted to the lid;
a power source disposed along said base plate;
a power actuator disposed along said base plate and electrically connected to said power source;
a latch mechanism disposed along said base plate and operably connected to said power actuator for movement between a locked position and an unlocked position;
an interior light source coupled to said base plate and electrically connected to said power source to illuminate the interior storage compartment;
an exterior light source adapted to be mounted along an outboard surface of the lid and electrically connected to said power source to illuminate an area adjacent the box; and
a keyless entry receiver disposed along said base plate and operably coupled to a transmitter for operating at least one of said latch mechanism, said interior light source, and said exterior light source.

5. The modular powered accessory assembly as set forth in claim 4 including a cover fixedly secured to said base plate.

6. A method of opening a box, having a lid movable relative to a base, utilizing a remote control, the method comprising the steps of:
activating the remote control; and
unlocking the latch mechanism to move the lid relative to the base.

7. A method of remotely actuating at least one of an interior light source and an exterior light source for a box defining an interior storage compartment utilizing a remote control, the method comprising the steps of:
activating the remote control; and
turning on at least one of the interior and exterior light sources to illuminate at least one of the interior storage compartment and an area adjacent the box.
